(19) United States
(12) Patent Application Publication
(10) Pub. No.: US 2013/0316314 A1
(43) Pub. Date: Nov. 28, 2013

(54) Process for producing perfect-content-validity tests

(71) Applicant: Dah-Torng Ling, San Antonio, TX (US)

(72) Inventor: Dah-Torng Ling, San Antonio, TX (US)

(21) Appl. No.: 13/987,032

(22) Filed: Jun. 27, 2013

Related U.S. Application Data
(63) Continuation-in-part of application No. 13/065,220, filed on Mar. 17, 2011.

(51) Int. Cl. G09B 19/00

(52) U.S. Cl. CPC G09B 19/00
USPC 434/236

(57) ABSTRACT

This invention is a non-sampling process for producing tests with perfect content validity. The process begins with a complete listing of every nanoskill [the tiniest fragment of human behavior, experience, and knowledge] which exists in the entire body of subject matter to be tested. Next is to arrange these nanoskills in developmental sequence. Then, for each nanoskill, prepare a preliminary test item which requires the application of this nanoskill to arrive at a correct answer. Next is to check whether each preliminary test item requires the application of the nanoskill(s) demanded in the previous item. If yes, discard the previous item, move to next preliminary test item, and check for inclusion of nanoskill in the same manner. If no, keep both items, move to next item, and check for inclusion of nanoskill in the same manner. The remaining preliminary test items constitute the test items of the desired test.

### CROSS REFERENCE TO RELATED APPLICATIONS

Not applicable.

### STATEMENT REGARDING FEDERALLY SPONSORED RESEARCH . . .

Not applicable.

### REFERENCE TO SEQUENCE LISTING, A TABLE, OR . . .

Not applicable.

### BACKGROUND OF THE INVENTION

The following definitions are for the purpose of clarifying some concepts concerning this invention:
1. Test:
   A test is an evaluative instrument that can be used to measure achievement, performance, and/or other human attribute(s) through response-to-situation processes and that can be administered through any medium in audio form, visual form, audio-visual form, oral form, written form and/or printed form to individual person(s) and/or group(s) of persons.
2.Objective Test:
   An objective test is a test that has only one correct response (answer or solution) to each of the items (questions or problems) in the test.
3. Validity:
   Validity of a test is the degree, or extent, of the capability of the test to measure what is intended to measure.
4. Content Validity:
   Content validity of a test is the degree, or extent, of the capability of the test to measure some or all segments of a body of contents, or subject matter—usually through a set of sample points.
5. Perfect Content Validity:
   Perfect content validity of a test is the capability of the test to measure the entire detailedly defined body of contents, or subject matter, without any omission.
6. Nanoskill:
   A nanoskill is a specific fragment of human behavior, experience, and/or knowledge, acquired at the successful conclusion of a developmental teaching-learning step and is needed for advancing from this developmental step to a contiguous developmental step between which an intermediate developmental step cannot be defined or is not needed in a bona fide developmental teaching-learning process or situation.
   To clarify the definition of a nanoskill, the following example is in order. “Solving linear equations in one variable” is a subject-matter area, a topic, a sub-topic or a skill cluster. It includes many nanoskills and one of these nanoskills is: “Adding equal quantities onto both members (sides) of a given equation.”
7. Alternative Nanoskill:
   An alternative nanoskill is a closely related nanoskill (e.g., an inverse operation) with which a respondent may use to bypass the nanoskill being tested and earn the credit. Because these two nanoskills are normally taught and learned in pair or in succession, the credit given in such a bypass situation is fair and safe.
   For instance, in solving a very simple linear equation, the nanoskill of “subtracting equal quantities from both members (sides) of an equation” is being tested. Given: y+2=0, the expected nanoskill to be applied is “subtracting 2 from each side.” However, instead, a respondent may use an alternative nanoskill of “adding −2 onto each side” to obtain credit for the nanoskill being tested.
8. Perfect-Content-Validity Objective Test:
   A perfect-content-validity objective test (PCV test) is an objective test which demands the application of all nanoskills utilized to define the entire subject-matter area to be tested.

One of the fundamental considerations in producing or selecting an objective test is its validity. Concerning the validity of a test, the basic question is: “How well can this test measure what is intended to measure?” Or, “What is the degree of certainty or uncertainty that this test can measure all subject-matter contents inside the defined area?”

Traditionally, production of objective tests relies on a sampling, or spot-checking, process. Roughly, the major activities are:
1. Establish a list of topics, or categories, in the area which is to be tested.
2. Under each topic on the list, choose a sample of subtopics for test item preparation.
3. Under each subtopic, prepare a sample of test items with different levels of difficulty.
4. According to the levels of difficulty and/or other criteria, edit and rearrange the test items.
5. Prepare and analyze multiple-choice responses to the test items and edit the entire instrument.

Due to the very nature of sampling, a traditional objective test measures only some chosen sample points within the defined subject-matter area but not the entire body of the subject matter. The result from testing these sample points is arbitrarily used as the measurement of the entire body of subject matter—with some degree of certainty or uncertainty. Since the test does not measure the entire body of subject matter, one hundred percent, or perfect content validity can never be achieved. In addition, for answers, the usual multiple-choice format simply increases the degree of uncertainty.

For example, the mathematics portions of the SAT, the ACT and the TASP (THEA) are traditional objective tests. Usually, these objective test have some established norms (mean, median and/or mode) as standards for comparison; consequently, these tests are also referred to as standardized tests. These traditional tests do have their own merits—e.g., a small number of test items can cover a large area of subject matter within a short test session. For admission, comparison, graduation and research, these traditional objective tests are very efficient.

### BRIEF SUMMARY OF THE INVENTION

This invention is a non-sampling process for producing objective tests with perfect content validity for human respondents. A test with perfect content validity can be used to ascertain a human respondent's complete readiness for the next level of learning. It eliminates under-preparedness and reduces frustration on teachers as well as learners. Using sampling technique, all well-known traditional standardized tests have their own merits but are unable to ascertain complete readiness for the next level of learning.

### BRIEF DESCRIPTION OF THE SEVERAL VIEWS OF THE DRAWING

Not applicable.

### DETAILED DESCRIPTION OF THE INVENTION

This invention is a non-sampling nanoskills-inclusive mastery-demanded open-answer process for producing perfect-content-validity objective tests. The process requires these steps:
1. Establish a comprehensive list of all nanoskill—fragments of human behavior, experience and knowledge—which exist in the entire body of subject matter to be tested.
2. Arrange all nanoskills from Step 1 in a bona fide developmental sequence.
3. For each nanoskill in the sequence established in Step 2, prepare a preliminary test item which requires the application of the nanoskill to arrive at a correct answer.
4. Label the first preliminary test item in the sequence with “N” and check the second item whether it requires the application of the nanoskill demanded in the first item.
   A. If yes, label this item with “Y” or
   B. If no, label this item with “N”.
5. Check whether the third preliminary test item requires the application of the nanoskills demanded in the previous two items.
   A. If yes, label this item with “Y” or
   B. If no, label this item with “N”.
6. Check the labels assigned to the second and the third items in the sequence.
   A. If “YY”, “NN” or “NY”, go to Step 7, or
   B. If “YN”, earmark the Y-label item with “C” before going to Step 7,
7. Check whether the next preliminary test item along the sequence requires the application of the nanoskill(s) demanded in the previous item.
   A. If yes, label this item with “Y” or
   B. If no, label this item with “N”.
8. Check the two labels most recently assigned.
   A. If “YY” or “NY” which belong to the last two items in the sequence, earmark “C” by the last Y-label item and go to Step 9.
   B. If “NN” which belong to the last two items in the sequence, earmark “C” by these two items and by other N-label items preceding these two items up to the last Y-label item, if any, and go to Step 9.
   C. If “YN” which belong to the last two items in the sequence, earmark “C” by each of these two items and go to Step 9.
   D. If “YY”, “NN”, or “NY” which do not belong to the last two items in the sequence, go back to Step 7.
   E. If “YN” which do not belong to the last two items in the sequence, earmark “C” by the Y-label item and go back to Step 7.
9. Collect all items earmarked “C” as final test items to produce a perfect-content-validity test.

A flowchart, which is intended to systemize the above-described steps, is included under “DRAWINGS” of this specification.

Since a test thus produced demands the application of all nanoskills covering the entire body of subject matter, it measures completely what is intended to measure and, therefore, it has perfect content validity. In other words, students who can respond to all test items correctly must have mastered all nanoskills defining the entire subject matter—not just a set of chosen sample points. Teachers who attempt to “teach” a mandated test are automatically forced to teach all nanoskills defining the entire curriculum. This is a teach-proof test!

An instrument of this type can also be used to ascertain complete readiness for promotion to the next level of learning. At the same time, it can be used to keep those who are under-prepared from entering into a course. In short, it can guarantee a no-void foundation to build on and will make a teaching-learning process more efficient.

### DRAWINGS

Please see the flowchart on next page. Please also note: In the flowchart, “inclusiveness” means that the required application of nanoskills leading to a correct answer for a test item includes the required application of nanoskill(s) leading to a correct answer for a previous test item in the sequence.

What is claimed is:

1. A method of non-sampling process for producing perfect-content-validity tests by:
Step 1: Establishing a comprehensive list of all nanoskills—fragments of human behavior, experience and knowledge—which exist in the entire subject matter area to be tested,
Step 2: Arranging all nanoskills from Step 1 in a bona fide developmental sequence,
Step 3: Preparing a sequence of preliminary test items each of which requires the application of a corresponding nanoskill in the sequence established in Step 2 to arrive at a correct answer,
Step 4: Labeling the first preliminary test item in the sequence with “N” and checking the second item whether it requires the application of the nanoskill demanded in the first item:
A. If yes, labeling this item with “Y” or
B. If no, labeling this item with “N”,
Step 5: Checking whether the third preliminary test item requires the applications of the nanoskills demanded in the previous two items:
A. If yes, labeling this item with “Y” or
B. If no, labeling this item with “N”,
Step 6: Checking the labels assigned to the second and the third items in the sequence:
A. If “YY”, “NN” or “NY”, going to Step 7, or
B. If “YN”, earmarking the Y-label item with “C” before going to Step 7,
Step 7: Checking whether the next preliminary test item along the sequence requires the application of the nanoskill demanded in the previous item:
A. If yes, labeling this item with “Y” or
B. If no, labeling this item with “N”,
Step 8: Checking the two labels most recently assigned:
A. If “YY” or “NY” which belong to the last two items in the sequence,
earmarking “C” by the last Y-label item and going to Step 9,
B. If “NN” which belong to the last two items in the sequence,
earmarking “C” by these two items and by other N-label items preceding these two up to the last Y-label item, if any, and going to Step 9,
C. If “YN” which belong to the last two items in the sequence, earmarking “C” by each of these two items and going to Step 9,
D. If “YY”, “NN”, or “NY” which do not belong to the last two items in the sequence, going back to Step 7, or
E. If “YN” which do not belong to the last two items in the sequence,
earmarking “C” by the Y-label item and going back to Step 7, and
Step 9: Collecting all items earmarked “C” as final test items to produce a perfect-content-validity test.
